(19) United States
(12) Patent Application Publication
(10) Pub. No.: US 2025/0277119 A1
(43) Pub. Date: Sep. 4, 2025

(54) MINERAL SILICATE SEALANT

(71) Applicants: Yossi Hai Hermon, Lehavim (IL); Michael Braunshtein, Bracha (IL)

(72) Inventors: Yossi Hai Hermon, Lehavim (IL); Michael Braunshtein, Bracha (IL)

(21) Appl. No.: 18/858,342

(22) PCT Filed: Jun. 18, 2023
(86) PCT No.: PCT/IL2023/050632

§ 371 Date: Oct. 22, 2024

Related U.S. Application Data
(60) Provisional application No. 63/392,133, filed on Jul. 26, 2022.

(51) Int. Cl. C09D 7/61; C08K 3/34; C09D 133/02; C09D 133/04

(52) U.S. Cl. CPC C09D 7/61; C09D 133/02; C09D 133/04; C08K 2003/343

(57) ABSTRACT

The present invention relates to a mineral silicate sealant which is highly durable, applied easily, and contains reduced toxic solvents. In some embodiments, the resin absorbs carbon dioxide from the atmosphere.

### RELATED APPLICATION/S

This application claims the benefit of priority under 35 USC § 119(e) of U.S. Provisional Patent Application No. 63/392,133 filed 26 Jul. 2022, the contents of which are incorporated herein by reference in their entirety.

### FIELD AND BACKGROUND OF THE INVENTION

The present invention in some embodiments thereof relates to a mineral silicate sealant and, more particularly, but not exclusively, to a mineral silicate sealant which is highly durable, applied easily, and does not contain toxic solvents.

The construction industry relies heavily on silicate sealants to waterproof and protect various building materials, including but not limited to concrete, wood, stone, etc. Most of these sealants contain toxic ingredients which are a health concern for the construction team and post-construction users. Application of the sealants can require numerous and complex applications, requiring significant time and expense. Additionally, these sealants are subject to cracking, peeling, and similar limitations of age.

Therefore, there is a need for a sealant which is highly durable, applied easily, and has reduced use of toxic solvents.

### SUMMARY OF THE INVENTION

According to an aspect of some embodiments of the invention, there is provided a sealant including: 8-45% wt/wt of an aqueous metal silicate solution including: 8-45% wt/wt of a metal silicate; 55-92% wt/wt water; and 55-92% wt/wt of a polymer resin.

According to some embodiments of the invention, the water temperature ranges between about 45° C. to about 75° C.

According to some embodiments of the invention, the metal silicate is an alkali metal silicate, alkali earth metal silicate, or a combination thereof.

According to some embodiments of the invention, the metal silicate is selected from the group consisting of sodium silicate, potassium silicate, and calcium silicate.

According to some embodiments of the invention, the sodium silicate is selected from the group consisting of sodium orthosilicate, sodium metasilicate, and sodium pyrosilicate.

According to some embodiments of the invention, the polymer resin is an acrylic polymer.

According to some embodiments of the invention, the resin is derived from acrylic acid, methacrylic acid and acrylate monomers, and combinations thereof.

According to some embodiments of the invention, a ratio of metal silicate to polymer resin is in the range 100:1 to 1:100.

According to some embodiments of the invention, the sealant is prepared prior to use in-situ and/or ex situ.

According to some embodiments of the invention, prepared sealant is stored in a closed container.

According to some embodiments of the invention, the sealant hardens on exposure to air.

According to some embodiments of the invention, the sealant hardens on exposure to atmospheric carbon dioxide.

According to some embodiments of the invention, the carbon dioxide diffuses through the sealant.

According to some embodiments of the invention, the sealant is applied as a thin layer.

According to some embodiments of the invention, the sealant is applied with a thickness of between about 40 g/m2 to about 70 g/m2.

According to some embodiments of the invention, the sealant is applied as a protective layer.

According to an aspect of some embodiments of the invention, there is provided a method of sealing a surface including applying a sealant including an aqueous mixture of metal silicate and a polymer resin to a surface; exposing the applied sealant to air; allowing the sealant to dry and harden, thereby sealing and protecting the surface with a durable sealant layer.

According to some embodiments of the invention, the applying is with a thickness of between about 40 g/m2 to about 70 g/m2.

According to some embodiments of the invention, the applying is by spraying, brushing, spreading, or a combination thereof.

According to some embodiments of the invention, the sealant penetrates the surface.

According to some embodiments of the invention, the exposing is to atmospheric carbon dioxide.

According to some embodiments of the invention, a rate of drying is dependent on moisture, humidity, wind, ambient temperature, thickness of applied layer, and any combination thereof.

According to some embodiments of the invention, the rate of drying when the ambient temperature is determined to be above approximately 25° C. is between approximately 2-2½ hours or more.

According to some embodiments of the invention, the rate of drying when the ambient temperature is determined to be below approximately 10° C. is between approximately 4-5 hours or more.

According to some embodiments of the invention, the rate of drying when the ambient temperature is determined to be between approximately 10° C. to approximately 20° C. is between approximately 3½−4 hours or more.

According to some embodiments of the invention, the rate of drying when the ambient temperature is determined to be between approximately 20° C. to approximately 25° C. is between approximately 3-3½ hours or more.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a flow chart of a method of preparing the sealant in accordance with some embodiments of the current invention.

FIG. 2 is a flow chart of a method of applying the sealant in accordance with some embodiments of the current invention.

FIG. 3 is a flow chart of drying times of the sealant based on ambient temperature in accordance with some embodiments of the current invention.

FIGS. 4A and 4B are schematic diagrams illustrating a manner in which the sealant may cover and/or penetrate a material to which it has been applied, in accordance with some embodiments of the current invention.

FIG. 5 is a block diagram of the sealant in accordance with some embodiments of the current invention.

### DESCRIPTION OF SPECIFIC EMBODIMENTS OF THE INVENTION

### Overview

The present invention in some embodiments thereof relates to a mineral silicate sealant and, more particularly, but not exclusively, to a mineral silicate sealant which is highly durable, applied easily, and does not contain toxic solvents.

An embodiment of a mineral silicate sealant incorporates a mineral silicate sealant. In some embodiments, the sealant may be simple to prepare, easy to apply (e.g., requiring only a single application) and/or is a “green” product which contains no or reduced toxic and/or volatile chemicals, and/or which provides a permanent, durable seal to a wide variety of surfaces. Additionally or alternatively, the mineral silicate sealant may capture atmospheric carbon dioxide and/or may reduce the carbon footprint of the construction industry.

An aspect of some embodiments of the current invention relates to a mineral silicate sealant. The following is presented to increase understanding of some embodiments of the invention without limiting the invention to a particular theoretical conceptualization. In some embodiments, the sealant possesses a high adherence into many materials onto which it is applied. For example, the sealant may penetrate the surface and/or base material. In some embodiments, the sealant solidifies in response to contact with air. In some embodiments, the sealant solidifies in response to contact with carbon dioxide. In some embodiments, the sealant crystallizes in response to contact with air. In an embodiment, the sealant forms a glass like material. Silicate nanoparticles may in some embodiments.

In some embodiments, the sealant may be permanent (e.g., may remain until the structure wears out and/or the presence of the sealant in the material may be irreversible). In some cases, the sealant may strengthen the infrastructure. Some embodiments of the sealant are suitable to be applied to a variety of surfaces without primer, such as, but not limited to: concrete and/or stone and/or marble and/or ceramic and/or wood and/or iron and/or plastic and/or plaster, gypsum, drywall, composite board and/or cement board and/or grout. In some embodiments, the sealant may be used outdoors (for example, for coating building sidings and/or to prevent seepage, prevent crumbling of new surfaces, prevent crumbling of old surfaces, seal facades, seal cladding, protect outdoor wooden structures (e.g., from sun, rain and/or changing temperatures), seal floors, seal balconies, protect concrete from dust, and/or serve as a primer for adhesives (e.g., when applying tiles)

For example, the hardened sealant may strengthen and/or seal with a high level of effectiveness. In some embodiments the sealant contains nanoparticles of silicate. Silicate nanoparticles may in some embodiments. For example, Silicate nanoparticles may enhance the sealant e.g., making it more repellant to water-repellent and/or to repel pollutants.

In some embodiments, the sealant creates a protective and sealing layer of silicate of silicon dioxide SiO₂ (glass). Optionally, the SiO₂ penetrates the surface. It may add durability against abrasion and/or salts and/or chemicals and/or may prevent crumbling and/or may provide resistance to UV, and/or may provide positive and/or negative sealing. Optionally, the sealant produces a hydrophobic surface. In some embodiments, the layer of Silicate is not subject to peeling. Optionally, the sealant may be used as a primer which allows adhesion of tiles and/or ceramics with cement adhesives. Optionally, a surface treated with the sealant may be painted and/or coated and/or tiled and/or attached to another object and/or another architectural element for example by means of adhesives. Optionally, the sealant can be applied to concrete fixtures to prevent the accumulation of dust. Optionally, the sealant can be applied to the flooring of bathrooms and terraces. Optionally, the sealant can be applied to wooden beams and trellises. Optionally, the sealant is suitable for both interior and/or exterior locations. Optionally, the sealant can be applied to natural and/or synthetic stones to prevent crumbling and/or to prevent water absorption. The sealant, in some embodiments (for example, in some of the embodiments disclosed herein), meets the some or all of the following industry standards: EN1504-2, ASTM C-156, ASTM D-4060, ASTM C 97-2009, and/or EN 12370-1999. In some embodiments, the compound may be made with recycled ingredients and/or recycled (e.g., after use and/or surplus compound may be recycled).

In some embodiments, the sealant may include a metal silicate. Optionally, the metal silicate may be an alkali metal silicate, or alkali earth metal silicate e.g., sodium silicate, potassium silicate, calcium silicate, etc. In some embodiments, the sealant may include a sodium silicate, such as sodium orthosilicate, sodium metasilicate, sodium pyrosilicate, etc. In some embodiments, the sealant may include a metasilicate, e.g., sodium metasilicate, potassium metasilicate, etc.

In some embodiments, the sealant may include a thermoplastic or thermosetting plastic substance. Optionally, the thermoplastic or thermosetting plastic substance may be a polymer resin. Optionally, the polymer resin may be an acrylic polymer, e.g., a resin derived from acrylic acid, methacrylic acid and acrylate monomers, such as butyl acrylate, methacrylate, etc. and combinations thereof.

In some embodiments, the sealant may include combining a metal silicate and a thermoplastic or thermosetting plastic substance. Optionally, the ratio of metal silicate to polymer resin may be in the range 10:0.1 to 10:1 and/or 10:1 to 10:5 and/or between 10:5 to 10:1 and/or between 10:1 to 5:10 and/or between 5:10 to 1:10 and/or between 1:10 to 0.1:10 by mass. Optionally, the sealant may include water. For example, the ratio of silicate to water resin may be in the range 10:0.1 to 10:1 and/or 10:1 to 10:5 and/or between 10:5 to 10:1 and/or between 10:1 to 5:10 and/or between 5:10 to 1:10 and/or between 1:10 to 0.1:10 by mass. Optionally, the sealant may be prepared prior to use. Optionally, the sealant may be prepared in-situ and/or ex situ. Optionally, the sealant may be prepared and stored in a closed container. Optionally, the sealant may be stored in a closed container for an extended period of time. Optionally, the sealant may be prepared as a ready to use composition.

In some embodiments, the compound (for example, as a liquid ready for application) may have a density between 1.06 to 1.15 kg/l and/or between 1 to 1.06 kg/l and/or between 0.9 to 1 kg/l and/or between 1.15 to 1.5 kg/l. Optionally, the compound may have a pH of between 10-12 and/or between 8 to 10 and/or between 12 to 14 and/or between 4 to 8. Optionally the compound is between 50 to 79% solids and/or between 70 to 85% solids and/or between 85 to 100% solids. Optionally, the compound is applied at a rate of one liter per 10-15 m² of surface and/or per 5-10 m² and/or per 15-30 m². In some embodiments, the sealant may be prepared in different forms for different surfaces. For example, there may be formulas (e.g., for use of different surfaces). For example, there may be a form for use as—waterproof sealer by impregnation for application on stone, concrete, etc. For example, there may be a form for use as—water-repellent sealer in impregnation to strengthen a crumbling mineral infrastructure. For example, there may be a form for use as a sealing liquid for spraying and reinforcing mineral/cement infrastructure according to TI 6422. For example, there may be a form for use as—liquid for sealing bathrooms and/or tiled balconies. For example, there may be a form for use as—curing compound liquid for improving cement and mineral infrastructures. For example, there may be a form for use as—bonding liquid that glues different substructures together for optimal adhesion.

In some embodiments, the sealant may be used on wood. For example, inhibiting liquid seepage and/or provide reinforcement and/or providing mechanical protection to the wood. In some embodiments, the compound may be diversified with acrylic pigments and/or with water (e.g., to give a brown shade to the wood). Optionally, the compound allows the wood to “breath”, and/or protects and/or preserves the wood. for many years without fading.

In some embodiments, the sealant may harden on exposure to air. Optionally, the sealant may harden on exposure to atmospheric carbon dioxide. Optionally, the carbon dioxide may diffuse through the sealant. In some embodiments, the sealant may be applied as a thin layer, e.g., as a protective layer and/or sealant. Optionally the sealant may be applied in a quantity of between about 10 g/m² to about 40 g/m², and/or between about 40 g/m² to about 70 g/m², and/or between about 70 g/m² to about 100 g/m², and/or between about 100 g/m² to about 200 g/m², and/or between about 200 g/m² to about 500 g/m².

### Exemplary Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

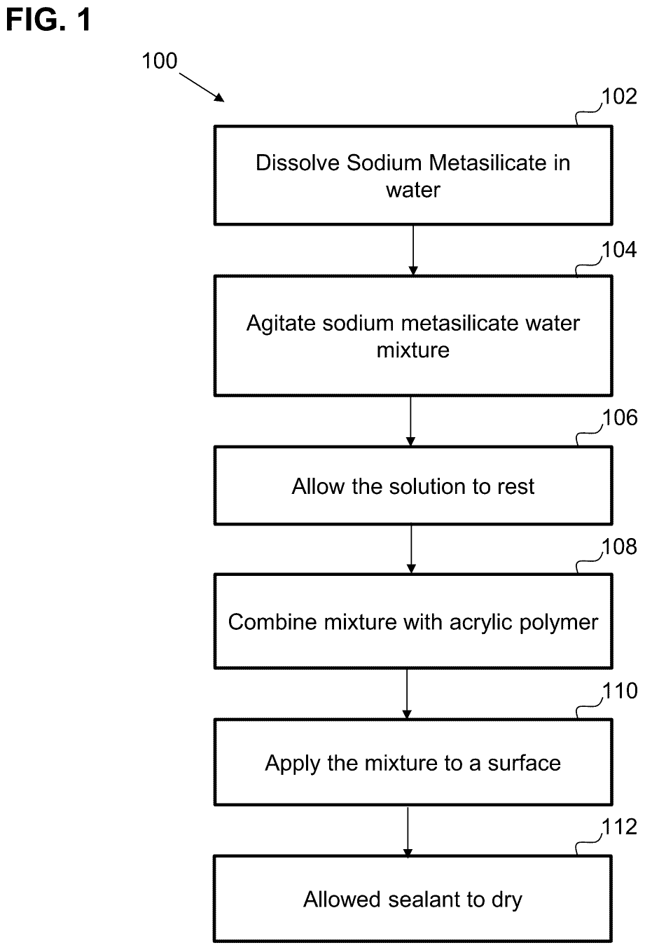

FIG. 1 is a flow chart of a method of preparing the sealant in accordance with an embodiment of the current invention. For example, in method 100, metasilicate, e.g., sodium metasilicate (CAS 10213-79-3), is dissolved 102 in water. For example, dissolution may be at a water temperature ranging between about 45° C. to about 55° C., and/or between about 55° C. to about 65° C., and/or between about 65° C. to about 75° C. The resultant solution may be, for example, between approximately 8-20% wt/wt, and/or between approximately 20-38% wt/wt, and/or between approximately 38-45% wt/wt metasilicate, and between approximately 80-92% wt/wt and/or between approximately 62-80% wt/wt and/or between approximately 55-62% wt/wt water.

The mixture of metasilicate and water is agitated 104. For example, agitation may continue until the metasilicate is dissolved. Optionally, agitation may be stirring, sonication, shaking, etc. and/or any combination thereof. Optionally, after agitation, the mixture is allowed to rest 106, for example until it equilibrates with the ambient temperature.

The metasilicate solution is mixed 108 together with the acrylic polymer, resulting in a solution which is between approximately 8-20% wt/wt and/or between approximately 20-38% wt/wt and or between approximately 38-45% wt/wt metasilicate solution, and/or between approximately 80-92% wt/wt and/or between approximately 62-80% wt/wt and/or between approximately 55-62% wt/wt acrylic polymer. Alternatively or additionally, the water metasilicate and polymer may be mixed together at the beginning of the process and/or the polymer may be mixed into the metasilicate solution with a no rest 106 period and/or a reduced rest period and/or an increased rest period. In some embodiments, the sealant may protect a surface from scratches,

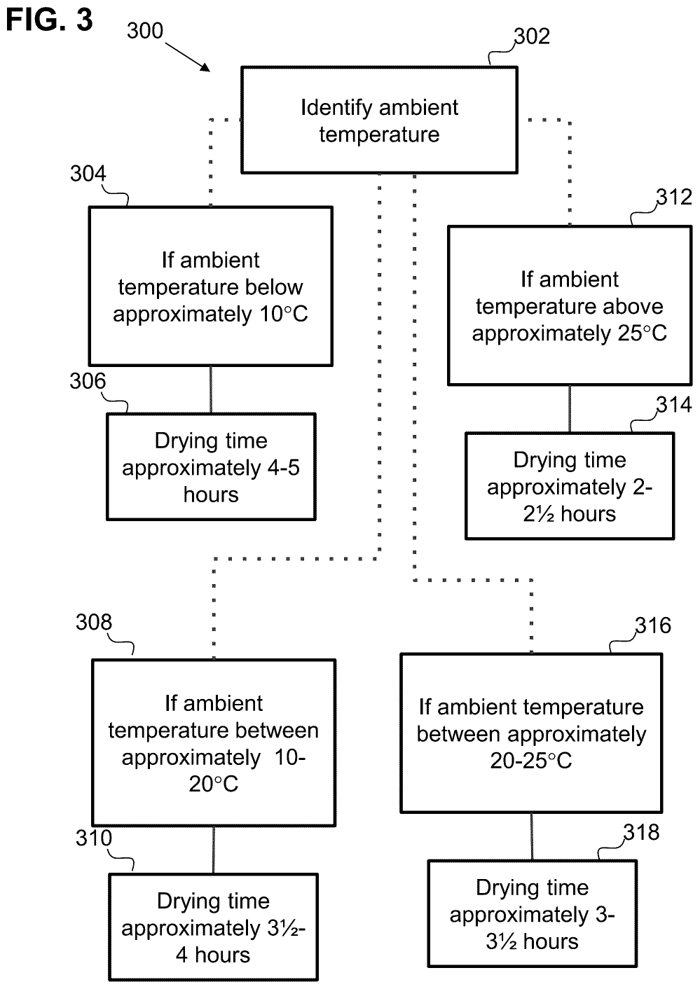

In some embodiments, the sealant is applied 110 to the desired surface. For example, application may include by spraying, brushing, spreading, etc. Optionally, the sealant is allowed to dry 112, thereby sealing and/or protecting the surface with a durable sealant layer. For example, optional recommended amounts of time are illustrated in FIG. 3.

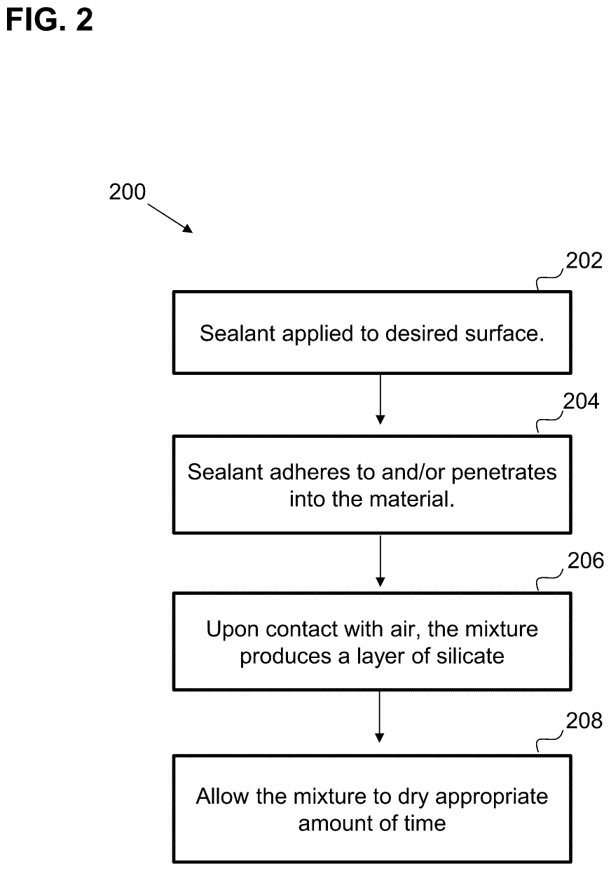

FIG. 2 is a flow chart of a method of applying the sealant in accordance with an embodiment of the current invention. For example, in method 200, the sealant is applied 202 to the desired surface, e.g., by spraying, brushing, spreading, etc. or a combination thereof. In some embodiments the sealant penetrates 204 into the material onto which it has been applied. In some embodiments the sealant, upon contact with air, producing 206 a layer of silicate (silicon dioxide—SiO₂ (e.g., glass)). In some embodiments, the mixture is allowed 208 to dry for an appropriate amount of time. For example, the appropriate amount time may depend on the ambient temperature (e.g., see FIG. 3).

FIG. 3 is a flow chart of drying times of the sealant based on ambient temperature in accordance with an embodiment of the current invention. For example, in method 300, the user determines 302 the ambient temperature of area of the surface to which the sealant has been applied and/or the rate of application (e.g., more drying time for a thicker coat). When the ambient temperature is determined to be above approximately 25° C. 312, the sealant may be allowed to dry between approximately 2-2½ hours or more 314. Alternatively, and/or additionally, when the ambient temperature is determined to be below approximately 10° C. 304, the sealant may be allowed to dry between approximately 4-5 hours or more 306. Alternatively, and/or additionally, when the ambient temperature is determined to be between approximately 10° C. to approximately 20° C. 308, the sealant may be allowed to dry between approximately 3½−4 hours or more 310. Alternatively, and/or additionally, when the ambient temperature is determined to be between approximately 20° C. to approximately 25° C. 316, the sealant may be allowed to dry between approximately 3-3½ hours or more 318. These figures are estimates, subject to variation based on varying conditions of application, for example, moisture, humidity, wind, temperature, thickness of applied layer, etc., and any combination thereof. In some embodiments the sealant reaches final solidification approximately 11-17 days after completing the application.

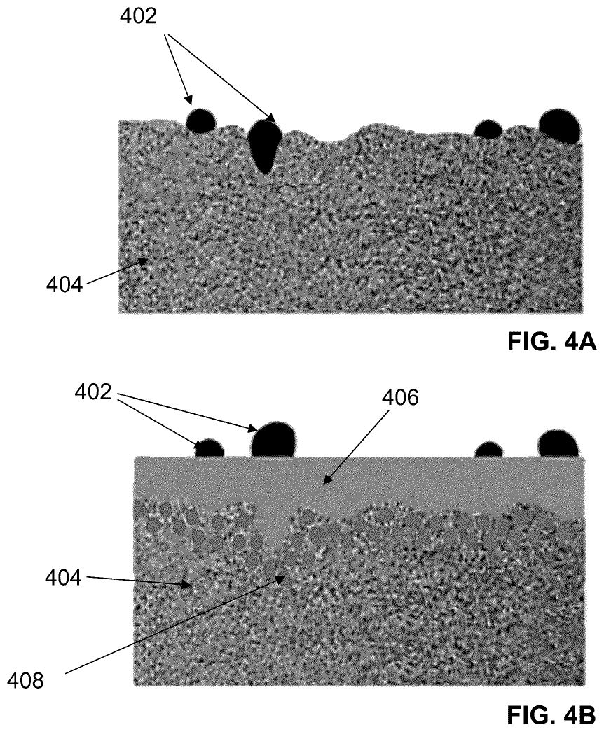

FIGS. 4A and 4B are schematic diagrams illustrating a manner in which the sealant may cover and/or penetrate a material to which it has been applied, in accordance with some embodiments of the current invention without limiting the invention to a particular theoretical conceptualization. For example, damaging external elements 402, such as, water, pollution, salts, chemicals, dirt, etc. may contact and/or penetrate material surface 404. The sealant is applied and to the material surface 404, forming a surface layer 406 and nano-molecules of sealant penetrating the material surface 408 thereby strengthening and/or protecting the surface material from damaging external elements 402.

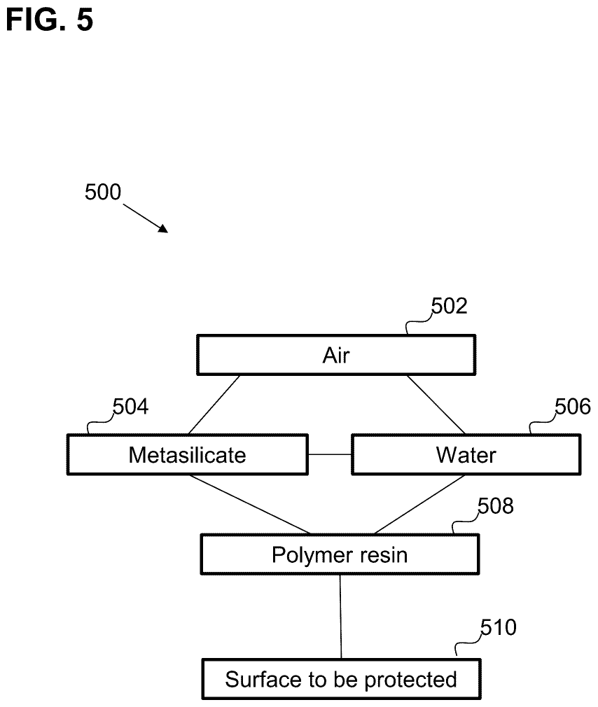

FIG. 5 is a block diagram illustrating the sealant in accordance with some embodiments of the current invention. For example, sealant 500 includes a metasilicate 504 mixed with water 506, agitated, then mixed with a polymer resin 508, and applied to a surface to be protected 510. Exposure of the applied sealant to the air 502, allowing the sealant to dray and harden, thereby sealing and/or protecting the surface with a durable sealant layer.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

It is expected that during the life of a patent maturing from this application many relevant technologies will be developed and the scope of the terms are intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A sealant comprising:
8-45% wt/wt of an aqueous metal silicate solution comprising:
8-45% wt/wt of a metal silicate;
55-92% wt/wt water; and
55-92% wt/wt of a polymer resin.

2. The sealant of claim 1, wherein the water temperature ranges between about 45° C. to about 75° C.

3. The sealant of claim 1, wherein the metal silicate is an alkali metal silicate, alkali earth metal silicate, or a combination thereof.

4. The sealant of claim 3, wherein the metal silicate is selected from the group consisting of sodium silicate, potassium silicate, and calcium silicate.

5. The sealant of claim 4, wherein the sodium silicate is selected from the group consisting of sodium orthosilicate, sodium metasilicate, and sodium pyrosilicate.

6. The sealant of claim 1, wherein the polymer resin is an acrylic polymer.

7. The sealant of claim 6, wherein the resin is derived from acrylic acid, methacrylic acid and acrylate monomers, and combinations thereof.

8. The sealant of claim 1, wherein a ratio of metal silicate to polymer resin is in the range 100:1 to 1:100.

9. The sealant of claim 1, wherein the sealant is prepared prior to use in-situ and/or ex situ.

10. The sealant of claim 9, wherein prepared sealant is stored in a closed container.

11. The sealant of claim 1, wherein the sealant hardens on exposure to air.

12. The sealant of claim 11, wherein the sealant hardens on exposure to atmospheric carbon dioxide.

13. The sealant of claim 12, wherein the carbon dioxide diffuses through the sealant.

14. The sealant of claim 1, wherein the sealant is applied as a thin layer.

15. The sealant of claim 14, wherein the sealant is applied with a thickness of between about 40 g/m² to about 70 g/m².

16. The sealant of claim 1, wherein the sealant is applied as a protective layer.

17. A method of sealing a surface comprising
applying a sealant comprising an aqueous mixture of metal silicate and a polymer resin to a surface;
exposing the applied sealant to air;
allowing the sealant to dry and harden, thereby sealing and protecting the surface with a durable sealant layer.

18. The method of claim 17, wherein the applying is with a thickness of between about 40 g/m² to about 70 g/m.

19. The method of claim 18, wherein the applying is by spraying, brushing, spreading, or a combination thereof.

20. The method of claim 17, wherein the sealant penetrates the surface.

21. The method of claim 17, wherein the exposing is to atmospheric carbon dioxide.

22. The method of claim 17, wherein a rate of drying is dependent on moisture, humidity, wind, ambient temperature, thickness of applied layer, and any combination thereof.

23. The method of claim 22, wherein the rate of drying when the ambient temperature is determined to be above approximately 25° C. is between approximately 2-2½ hours or mom.

24. The method of claim 22, wherein the rate of drying when the ambient temperature is determined to be below approximately 10° C. is between approximately 4-5 hours or more.

25. The method of claim 22, wherein the rate of drying when the ambient temperature is determined to be between approximately 10° C. to approximately 20° C. is between approximately 3½-4 hours or more.

26. The method of claim 22, wherein the rate of drying when the ambient temperature is determined to be between approximately 20° C. to approximately 25° C. is between approximately 3-3½ hours or more.
